(19) United States
(12) Patent Application Publication
(10) Pub. No.: US 2023/0090745 A1
(43) Pub. Date: Mar. 23, 2023

(54) DOORBELL COMMUNICATION SYSTEMS AND METHODS

(71) Applicant: SkyBell Technologies IP, LLC, Irvine, CA (US)

(72) Inventor: Joseph Frank Scalisi, Yorba Linda, CA (US)

(21) Appl. No.: 18/054,129

(22) Filed: Nov. 9, 2022

Related U.S. Application Data
(63) Continuation of application No. 16/999,016, filed on Aug. 20, 2020, now abandoned.
Application No. 16/999,016 is a continuation of application No. 15/701,453, filed on Sep. 12, 2017, now abandoned.
Application No. 15/701,453 is a continuation of application No. 14/861,613, filed on Sep. 22, 2015, now Pat. No. 10,044,519.
Application No. 14/861,613 is a continuation-in-part of application No. 14/740,199, filed on Jun. 15, 2015, now Pat. No. 9,197,867.
Application No. 16/999,016 is a continuation of application No. 15/701,451, filed on Sep. 12, 2017, now abandoned.
Application No. 15/701,451 is a continuation of application No. 14/861,613, filed on Sep. 22, 2015, now Pat. No. 10,044,519.
Application No. 14/861,613 is a continuation-in-part of application No. 14/740,199, filed on Jun. 15, 2015, now Pat. No. 9,197,867.
Application No. 14/861,613 is a continuation-in-part of application No. 14/743,849, filed on Jun. 18, 2015, now Pat. No. 9,172,922.
Application No. 14/743,849 is a continuation-in-part of application No. 14/684,302, filed on Apr. 10, 2015, now Pat. No. 9,113,052.
Application No. 14/684,302 is a continuation-in-part of application No. 14/612,376, filed on Feb. 3, 2015, now Pat. No. 9,058,738.
Application No. 14/612,376 is a continuation-in-part of application No. 14/589,830, filed on Jan. 5, 2015, now Pat. No. 9,060,104.
Application No. 14/589,830 is a continuation-in-part of application No. 14/502,601, filed on Sep. 30, 2014, now Pat. No. 9,094,584.
Application No. 14/502,601 is a continuation-in-part of application No. 14/492,809, filed on Sep. 22, 2014, now Pat. No. 9,065,987.
Application No. 14/492,809 is a continuation-in-part of application No. 14/275,811, filed on May 12, 2014, now Pat. No. 8,872,915.
Application No. 14/275,811 is a continuation-in-part of application No. 14/142,839, filed on Dec. 28, 2013, now Pat. No. 8,842,180.
(60) Provisional application No. 62/016,050, filed on Jun. 23, 2014.
(60) Provisional application No. 62/016,053, filed on Jun. 23, 2014.
(60) Provisional application No. 62/016,057, filed on Jun. 23, 2014.
(60) Provisional application No. 62/135,133, filed on Mar. 18, 2015.
(60) Provisional application No. 61/872,439, filed on Aug. 30, 2013.
(60) Provisional application No. 61/859,070, filed on Jul. 26, 2013.

(51) Int. Cl. H04L 12/28; H04M 11/02; H04M 1/02; G08B 3/10; H04N 7/18

(52) U.S. Cl. CPC H04L 12/2818; H04M 11/025; H04M 1/0291; G08B 3/10; H04L 12/2825; H04N 7/186; H04L 2012/2849; H04N 7/188; G08B 13/19684

(57) ABSTRACT

Doorbell systems can include a speaker and a visitor detection system that includes at least one of a button, a camera, and a motion detector. Doorbell systems can be configured to detect an identity of a visitor via facial recognition, initiate a communication session with a remote computing device, and send the identity to the remote computing device via the first communication session.

### CROSS-REFERENCE TO RELATED APPLICATIONS

The entire contents of the following application are incorporated by reference herein: U.S. Non-Provisional patent application Ser. No. 16/999,016; filed Aug. 20, 2020; entitled DOORBELL COMMUNICATION SYSTEMS AND METHODS.

The entire contents of the following application are incorporated by reference herein: U.S. Non-Provisional patent application Ser. No. 15/701,451; filed Sep. 12, 2017; entitled DOORBELL COMMUNICATION SYSTEMS AND METHODS.

The entire contents of the following application are incorporated by reference herein: U.S. Non-Provisional patent application Ser. No. 15/701,453; filed Sep. 12, 2017; entitled DOORBELL COMMUNICATION SYSTEMS AND METHODS.

The entire contents of the following application are incorporated by reference herein: U.S. Non-Provisional patent application Ser. No. 14/861,613; filed Sep. 22, 2015; issued as U.S. Pat. No. 10,044,519 on Aug. 7, 2018; entitled DOORBELL COMMUNICATION SYSTEMS AND METHODS.

The entire contents of the following application are incorporated by reference herein: U.S. Non-Provisional patent application Ser. No. 14/740,199; filed Jun. 15, 2015; issued as U.S. Pat. No. 9,197,867 on Nov. 24, 2015; entitled IDENTITY VERIFICATION USING A SOCIAL NETWORK.

The entire contents of the following application are incorporated by reference herein: Provisional Patent Application No. 62/135,133, filed Mar. 18, 2015; entitled DOORBELL COMMUNICATION SYSTEMS AND METHODS; and having an attorney docket number SKYBELL.012PR4.

The entire contents of the following application are incorporated by reference herein: U.S. Provisional Patent Application No. 62/016,057, filed Jun. 23, 2014; entitled IDENTITY VERIFICATION OF FREQUENT AND NON-FREQUENT VISITORS; and having an

The entire contents of the following application are incorporated by reference herein: U. SKYBELL.012PR2.

The entire contents of the following application are incorporated by reference herein: U.S. Provisional Patent Application No. 62/016,050, filed Jun. 23, 2014; entitled IDENTITY VERIFICATION USING A SOCIAL NETWORK; and having an attorney docket number SKYBELL.012PR1.

The entire contents of the following application are incorporated by reference herein: U.S. Non-Provisional patent application Ser. No. 14/737,411; filed Jun. 11, 2015; issued as U.S. Pat. No. 9,160,987 on Oct. 13, 2015; entitled DOORBELL CHIME SYSTEMS AND METHODS; and having an attorney docket number SKYBELL.043A.CP4.

The entire contents of the following application are incorporated by reference herein: U.S. Non-Provisional patent application Ser. No. 14/743,849, filed Jun. 18, 2015; issued as U.S. Pat. No. 9,172,922 on Oct. 27, 2015; entitled DOORBELL COMMUNICATION SYSTEMS AND METHODS; and having an attorney docket number SKYBELL.009A.CP11.

The entire contents of the following application are incorporated by reference herein: U.S. patent application Ser. No. 14/612,376; filed Feb. 3, 2015; issued as U.S. Pat. No. 9,058,738 on Jun. 16 2015; and entitled DOORBELL COMMUNICATION SYSTEMS AND METHODS.

The entire contents of the following application are incorporated by reference herein: U.S. patent application Ser. No. 14/589,830; filed Jan. 5, 2015; issued as U.S. Pat. No. 9,060,104 on Apr. 30, 2015; and entitled DOORBELL COMMUNICATION SYSTEMS AND METHODS.

The entire contents of the following application are incorporated by reference herein: U.S. patent application Ser. No. 14/623,741; filed Feb. 17, 2015; issued as U.S. Pat. No. 9, 1 13,051 on Aug. 18, 2015; and entitled POWER OUTLET CAMERAS;

The entire contents of the following application are incorporated by reference herein: U.S. patent application Ser. No. 14/748,054; filed Jun. 23, 2015; issued as U.S. Pat. No. 9,230,424 on Jan. 5, 2016; and entitled DOORBELL COMMUNITIES.

The entire contents of the following application are incorporated by reference herein: U.S. patent application Ser. No. 14/502,601; filed Sep. 30, 2014; issued as U.S. Pat. No. 9,094,584 on Jul. 28, 2015; and entitled DOORBELL COMMUNICATION SYSTEMS AND METHODS.

### BACKGROUND

### Field

Various embodiments disclosed herein relate to doorbells. Certain embodiments relate to communication between a person near a doorbell and a person in another location.

### Description of Related Art

Homes, offices, and other buildings sometimes include communication and surveillance systems to enable friendly visitors to summon occupants of the buildings and to deter unwanted visitors. Communication and surveillance systems can include video cameras and doorbells.

Doorbells can enable a person located outside of an entry point, such as a door, to alert a person inside of an entry point that someone outside would like to talk to someone inside. Doorbells sometimes include a button located near a door, such as a front door, side door, or back door of a home, office, dwelling, warehouse, building, or structure. Doorbells are sometimes used near a gate or some other entrance to a partially enclosed area. Pushing the doorbell sometimes causes a chime or other alerting sound to be emitted. In some cases, this alerting sound can typically be heard within a short distance from the entry point or sound source. For example, a homeowner located remotely from her home likely would not be able to hear the alerting sound, and thus, would not be aware that someone is ringing her doorbell. Thus, there is a need for devices and methods to alert remotely located individuals that someone seeks the attention of the homeowner, tenant, building guardian, or steward.

### SUMMARY

This disclosure includes methods of operating doorbell systems. A doorbell system can comprise a speaker, a microphone, and a visitor detection system. The visitor detection system can comprise at least one of a button, a camera, and a motion detector. The method can comprise detecting a first indication of a first visitor, and then in response to detecting the first indication, contacting a first resident. The method may also include detecting a second indication of a second visitor, and then in response to detecting the second indication, contacting a second resident.

Methods can further include detecting, via voice recognition, a first identity of the first visitor, and then in response to detecting the first identity, contacting the first resident. As well, methods can include detecting, via voice recognition, a second identity of the second visitor, and then in response to detecting the second identity, contacting the second resident.

Methods can also include detecting, via facial recognition, a first identity of the first visitor, and then in response to detecting the first identity, contacting the first resident. Methods can include detecting, via facial recognition, a second identity of the second visitor, and then in response to detecting the second identity, contacting the second resident.

As well, methods can include detecting a first motion of the first visitor, wherein the first motion defines a first identity of the first visitor, and then in response to detecting the first identity, contacting the first resident. Methods can also include detecting a second motion of the second visitor, wherein the second motion defines a second identity of the second visitor, and then in response to detecting the second identity, contacting the second resident.

Furthermore, methods can include detecting, via voice recognition, a first identity of the first visitor, and then in response to detecting the first identity, emitting a noise with a first chime located within a first unit of the first resident. The first chime can be communicatively coupled to the doorbell. Methods can also include detecting, via voice recognition, a second identity of the second visitor, and then in response to detecting the second identity, emitting a noise with a second chime located within a second unit of the second resident. The second chime can be communicatively coupled to the doorbell. The first unit can comprise a first residential unit, and the second unit can comprise a second residential unit. In embodiments, the first unit can comprise a first commercial unit, and the second unit can comprise a second commercial unit.

In embodiments, contacting the first resident can comprise initiating a communication session with a first remote computing device of the first resident, and contacting the second resident can comprise initiating a communication session with a second remote computing device of the second resident.

As well, detecting the first indication of the first visitor can comprise detecting a first name as spoken by the first visitor, and then in response to detecting the first name, methods can include contacting the first resident. Detecting the second indication of the second visitor can comprise detecting a second name as spoken by the second visitor, and then in response to detecting the second name, methods can include contacting the second resident.

Methods can further include receiving an indication of a button press by at least one of the first visitor and the second visitor. In response to the button press, methods can include emitting an audible message to ask the at least one of the first visitor and the second visitor to audibly speak a resident's name.

As well, methods can include receiving an indication of a button press by at least one of the first visitor and the second visitor. In response to the button press, methods can include emitting an audible message that includes two or more resident's names.

Methods can include electing to contact the first resident based on a time at which the doorbell detects the first indication. Methods can also include electing to contact the second resident based on a time at which the doorbell detects the second indication.

Furthermore, methods can include detecting an amount of light, electing to contact the first resident based on the amount of light, and electing to contact the second resident based on the amount of light.

Methods can include electing to contact the first resident based upon a first contact parameter, and electing to contact the second resident based upon a second contact parameter. The first contact parameter can comprise at least one of a time and an identity of the first visitor. As well, the second contact parameter can comprise at least one of a time and an identity of the second visitor.

The disclosure also includes a method of using a first doorbell to detect an indication of a high-risk visitor. The first doorbell can comprise a speaker, a microphone, and a visitor detection system. The visitor detection system can have at least one of a button, a camera, and a motion detector. The method can comprise receiving, via the first doorbell, data from a second doorbell that is located remote to the first doorbell. The data can comprise an indication of the high-risk visitor. As well, the method can include detecting an indication of a visitor. Then in response to detecting the indication of the visitor, the method can include determining whether the indication of the visitor substantially matches the indication of the high-risk visitor.

In response to determining that the indication of the visitor substantially matches the indication of the high-risk visitor, methods can include initiating an alert. In embodiments, the alert can comprise illuminating a light on the doorbell. In embodiments, the alert can comprise emitting a noise with a speaker of the doorbell. In embodiments, the alert can comprise initiating a communication session with a remote computing device to thereby inform a user of the remote computing device of the indication of the high-risk visitor.

In embodiments, the first doorbell can be indirectly communicatively coupled to the second doorbell via a remote computer. In embodiments, the first doorbell can be directly communicatively coupled to the second doorbell.

In embodiments, the first doorbell can be attached to a first building. In embodiments, the second doorbell can be attached to a second building located at least 50 feet from the first building.

Methods can include receiving, via the first doorbell, data from a third doorbell that is located remote to both the first and second doorbells. The data can comprise an indication of a second high risk visitor. In response to detecting the indication of the visitor, methods can include determining whether the indication of the visitor substantially matches the indication of the second high risk visitor.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a front view of a communication system, according to some embodiments.

FIG. 2 illustrates a computing device running software, according to some embodiments.

FIG. 3 illustrates an embodiment in which a security system is connected to a building, according to some embodiments.

FIG. 4 illustrates various identifying characteristics of a visitor, according to some embodiments.

FIG. 5 illustrates a network of security systems, according to some embodiments.

FIG. 6 illustrates a network of security systems, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The following patent is incorporated herein by reference: U.S. Pat. No. 7,583,191; entitled SECURITY SYSTEM AND METHOD FOR USE OF SAME; and filed Nov. 14, 2006.

Communication systems can provide a secure and convenient way for a remotely located individual to communicate with a person who is approaching a sensor, such as a proximity sensor or motion sensor, or with a person who rings a doorbell, which can be located in a doorway, near an entrance, or within 15 feet of a door. Some communication systems allow an individual to hear, see, and talk with visitors who approach at least a portion of the communication system and/or press a button, such as a doorbell's button. For example, communication systems can use a computing device to enable a remotely located person to see, hear, and/or talk with visitors. Computing devices can include computers, laptops, tablets, mobile devices, smartphones, cellular phones, and wireless devices (e.g., cars with wireless communication). Example computing devices include the iPhone, iPad, iMac, MacBook Air, and MacBook Pro made by Apple Inc. Communication between a remotely located person and a visitor can occur via the Internet, cellular networks, telecommunication networks, and wireless networks.

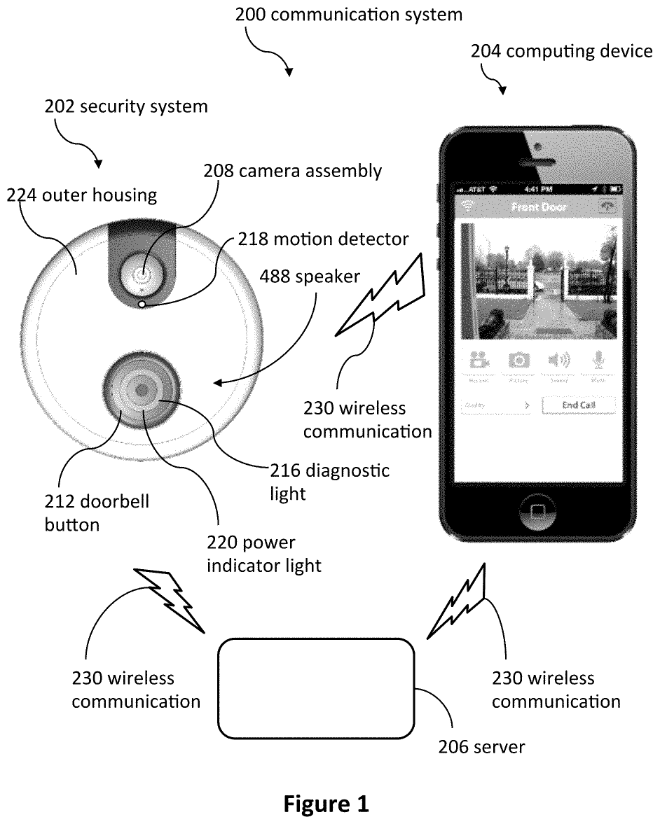

FIG. 1 illustrates a front view of a communication system embodiment. The communication system 200 can include a security system 202 (e.g., a doorbell) and a computing device 204. Although the illustrated security system 202 includes many components in one housing, several security system embodiments include components in separate housings. The security system 202 can include a camera assembly 208 and a doorbell button 212. The camera assembly 208 can be a video camera, which in some embodiments is a webcam.

The security system 202 can include a diagnostic light 216 and a power indicator light 220. In some embodiments, the diagnostic light 216 is a first color (e.g., blue) if the security system 202 and/or the communication system 200 is connected to a wireless Internet network and is a second color (e.g., red) if the security system 202 and/or the communication system 200 is not connected to a wireless Internet network. In some embodiments, the power indicator 220 is a first color if the security system 202 is connected to a power source. The power source can be power supplied by the building 300 to which the security system 202 is attached. In some embodiments, the power indicator 220 is a second color or does not emit light if the security system 202 is not connected to the power source.

As well, the security system 202 can include at least one speaker 488. The speaker 488 can be located along any portion of the security system 202. For example, the speaker 488 can be located within an inner portion of the security system 202 or along an outer portion of the security system 202. The speaker 488 can be any type of sound output device configured to emit sound, such as a digital speaker, an analog speaker, and the like.

Furthermore, the security system 202 (e.g., a doorbell) can include an outer housing 224, which can be water resistant and/or waterproof. The outer housing can be made from metal or plastic, such as molded plastic with a hardness of 60 Shore D. In some embodiments, the outer housing 224 is made from brushed nickel or aluminum.

Rubber seals can be used to make the outer housing 224 water resistant or waterproof The security system 202 can be electrically coupled to a power source, such as wires electrically connected to a building's electrical power system. In some embodiments, the security system 202 includes a battery for backup and/or primary power.

Wireless communication 230 can enable the security system 202 (e.g., a doorbell) to communicate with the computing device 204. Some embodiments enable communication via cellular and/or WiFi networks. Some embodiments enable communication via the Internet. Several embodiments enable wired communication between the security system 202 and the computing device 204. The wireless communication 230 can include the following communication means: radio, WiFi (e.g., wireless local area network), cellular, Internet, Bluetooth, telecommunication, electromagnetic, infrared, light, sonic, and microwave. Other communication means are used by some embodiments. In some embodiments, such as embodiments that include telecommunication or cellular communication means, the security system 202 can initiate voice calls or send text messages to a computing device 204 (e.g., a smartphone, a desktop computer, a tablet computer, a laptop computer).

Some embodiments include computer software (e.g., application software), which can be a mobile application designed to run on smartphones, tablet computers, and other mobile devices. Software of this nature is sometimes referred to as “app” software. Some embodiments include software designed to run on desktop computers and laptop computers.

The computing device 204 can run software with a graphical user interface. The user interface can include icons or buttons. In some embodiments, the software is configured for use with a touch-screen computing device such as a smartphone or tablet.

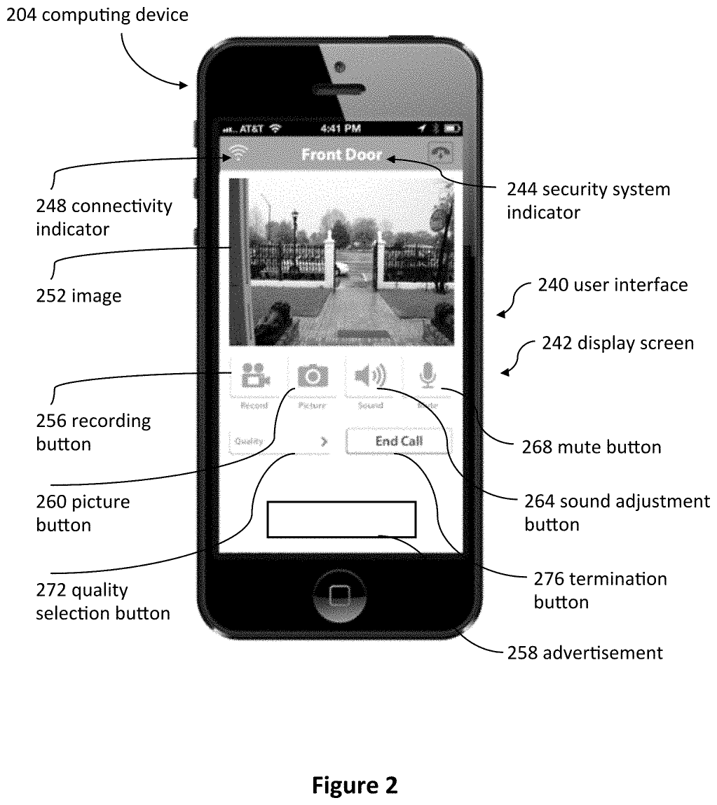

FIG. 2 illustrates a computing device 204 running software. The software includes a user interface 240 displayed on a display screen 242. The user interface 240 can include a security system indicator 244, which can indicate the location of the security system that the user interface is displaying. For example, a person can use one computing device 204 to control and/or interact with multiple security systems, such as one security system located at a front door and another security system located at a back door. Selecting the security system indicator 244 can allow the user to choose another security system (e.g., the back door security system rather than the front door security system).

The user interface 240 can include a connectivity indicator 248. In some embodiments, the connectivity indicator can indicate whether the computing device is in communication with a security system, the Internet, and/or a cellular network. The connectivity indicator 248 can alert the user if the computing device 204 has lost its connection with the security system 202; the security system 202 has been damaged; the security system 202 has been stolen; the security system 202 has been removed from its mounting location; the security system 202 lost electrical power; and/or if the computing device 204 cannot communicate with the security system 202. In some embodiments, the connectivity indicator 248 alerts the user of the computing device 204 by flashing, emitting a sound, displaying a message, and/or displaying a symbol.

In some embodiments, if the security system 202 loses power, loses connectivity to the computing device 204, loses connectivity to the Internet, and/or loses connectivity to a remote server, a remote server 206 sends an alert (e.g., phone call, text message, image on the user interface 240) regarding the power and/or connectivity issue. In several embodiments, the remote server 206 can manage communication between the security system 202 and the computing device. In some embodiments, information from the security system 202 is stored by the remote server 206. In several embodiments, information from the security system 202 is stored by the remote server 206 until the information can be sent to the computing device 204, uploaded to the computing device 204, and/or displayed to the remotely located person via the computing device 204. The remote server 206 can be a computing device that stores information from the security system 202 and/or from the computing device 204. In some embodiments, the remote server 206 is located in a data center.

In some embodiments, the computing device 204 and/or the remote server 206 attempts to communicate with the security system 202. If the computing device 204 and/or the remote server 206 is unable to communicate with the security system 202, the computing device 204 and/or the remote server 206 alerts the remotely located person via the software, phone, text, a displayed message, and/or a website. In some embodiments, the computing device 204 and/or the remote server 206 attempts to communicate with the security system 202 periodically; at least every five hours and/or less than every 10 minutes; at least every 24 hours and/or less than every 60 minutes; or at least every hour and/or less than every second.

In some embodiments, the server 206 can initiate communication to the computer device 204 and/or to the security system 202. In several embodiments, the server 206 can initiate, control, and/or block communication between the computing device 204 and the security system 202.

In several embodiments, a user can log into an “app,” website, and/or software on a computing device (e.g., mobile computing device, smartphone, tablet, desktop computer) to adjust the security system settings discussed herein.

In some embodiments, a computing device can enable a user to watch live video and/or hear live audio from a security system due to the user's request rather than due to actions of a visitor. Some embodiments include a computing device initiating a live video feed (or a video feed that is less than five minutes old).

In some embodiments, the user interface 240 displays an image 252 such as a still image or a video of an area near and/or in front of the security system 202. The image 252 can be taken by the camera assembly 208 and stored by the security system 202, server 206, and/or computing device 204. The user interface 240 can include a recording button 256 to enable a user to record images, videos, and/or sound from the camera assembly 208, microphone of the security system 202, and/or microphone of the computing device 204.

In several embodiments, the user interface 240 includes a picture button 260 to allow the user to take still pictures and/or videos of the area near and/or in front of the security system 202. The user interface 240 can also include a sound adjustment button 264 and a mute button 268. The user interface 240 can include camera manipulation buttons such as zoom, pan, and light adjustment buttons. In some embodiments, the camera assembly 208 automatically adjusts between Day Mode and Night Mode. Some embodiments include an infrared camera and/or infrared lights to illuminate an area near the security system 202 to enable the camera assembly 208 to provide sufficient visibility (even at night).

In some embodiments, buttons include diverse means of selecting various options, features, and functions. Buttons can be selected by mouse clicks, keyboard commands, and touching a touch screen. Many embodiments include buttons that can be selected without touch screens.

In some embodiments, the user interface 240 includes a quality selection button, which can allow a user to select the quality and/or amount of the data transmitted from the security system 202 to the computing device 204 and/or from the computing device 204 to the security system 202.

In some embodiments, video can be sent to and/or received from the computing device 204 using video chat protocols such as FaceTime (by Apple Inc.) or Skype (by Microsoft Corporation). In some embodiments, these videos are played by videoconferencing apps on the computing device 204 instead of being played by the user interface 240.

The user interface 240 can include a termination button 276 to end communication between the security system 202 and the computing device 204. In some embodiments, the termination button 276 ends the ability of the person located near the security system 202 (i.e., the visitor) to hear and/or see the user of the computing device 204, but does not end the ability of the user of the computing device 204 to hear and/or see the person located near the security system 202.

In some embodiments, a button 276 is both an answer button (to accept a communication request from a visitor) and is a termination button (to end communication between the security system 202 and the computing device 204). The button 276 can include the word “Answer” when the system is attempting to establish two-way communication between the visitor and the user. Selecting the button 276 when the system is attempting to establish two-way communication between the visitor and the user can start two-way communication. The button 276 can include the words “End Call” during two-way communication between the visitor and the user. Selecting the button 276 during two-way communication between the visitor and the user can terminate two-way communication. In some embodiments, terminating two-way communication still enables the user to see and hear the visitor. In some embodiments, terminating two-way communication causes the computing device 204 to stop showing video from the security system and to stop emitting sounds recorded by the security system.

In some embodiments, the user interface 240 opens as soon as the security system detects a visitor (e.g., senses indications of a visitor). Once the user interface 240 opens, the user can see and/or hear the visitor even before “answering” or otherwise accepting two-way communication, in several embodiments.

Some method embodiments include detecting a visitor with a security system. The methods can include causing the user interface to display on a remote computing device 204 due to the detection of the visitor (e.g., with or without user interaction). The methods can include displaying video from the security system and/or audio from the security system before the user accepts two-way communication with the visitor. The methods can include displaying video from the security system and/or audio from the security system before the user accepts the visitor's communication request. The methods can include the computing device simultaneously asking the user if the user wants to accept (e.g., answer) the communication request and displaying audio and/or video of the visitor. For example, in some embodiments, the user can see and hear the visitor via the security system before opening a means of two-way communication with the visitor.

In some embodiments, the software includes means to start the video feed on demand. For example, a user of the computing device might wonder what is happening near the security system 202. The user can open the software application on the computing device 204 and instruct the application to show live video and/or audio from the security device 202 even if no event near the security system 202 has triggered the communication.

In several embodiments, the security device 202 can be configured to record when the security device 202 detects movement and/or the presence of a person. The user of the computing device 204 can later review all video and/or audio records when the security device 202 detected movement and/or the presence of a person.

Referring now to FIG. 1, in some embodiments, the server 206 controls communication between the computing device 204 and the security system 202, which can be a doorbell with a camera, a microphone, and a speaker. In several embodiments, the server 206 does not control communication between the computing device 204 and the security system 202.

In some embodiments, data captured by the security system and/or the computing device 204 (such as videos, pictures, and audio) is stored by another remote device such as the server 206. Cloud storage, enterprise storage, and/or networked enterprise storage can be used to store video, pictures, and/or audio from the communication system 200 or from any part of the communication system 200. The user can download and/or stream stored data and/or storage video, pictures, and/or audio. For example, a user can record visitors for a year and then later can review conversations with visitors from the last year. In some embodiments, remote storage, the server 206, the computing device 204, and/or the security system 202 can store information and statistics regarding visitors and usage.

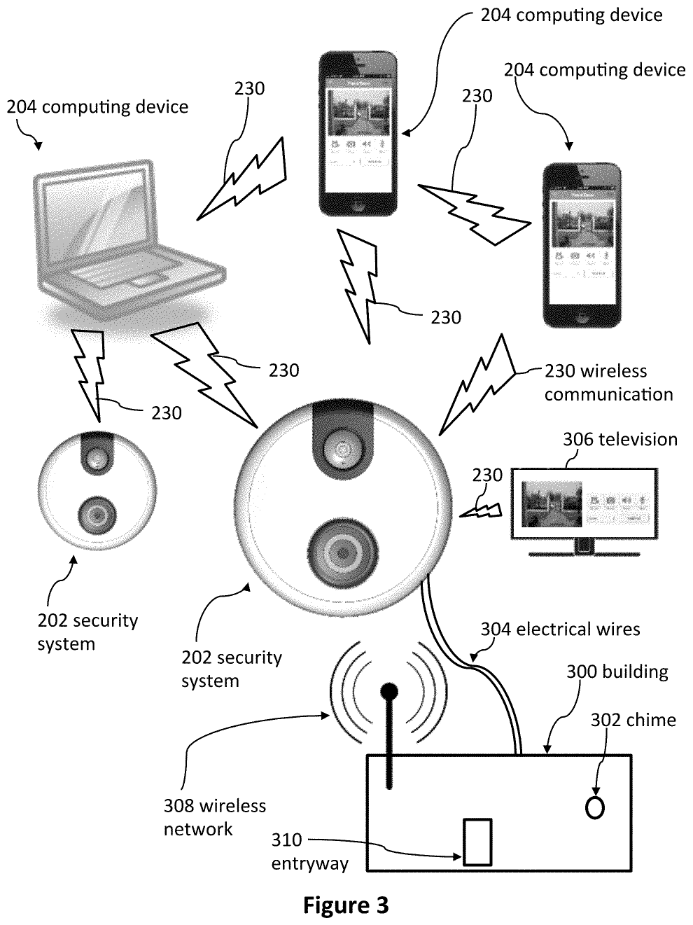

FIG. 3 illustrates an embodiment in which a security system 202 is connected to a building 300, which can include an entryway 310 that has a door 254. A door lock 250 can be configured to lock and unlock the door 254. Electrical wires 304 can electrically couple the security system 202 to the electrical system of the building 300 such that the security system 202 can receive electrical power from the building 300.

A wireless network 308 can allow devices to wirelessly access the Internet. The security system 202 can access the Internet via the wireless network 308. The wireless network 308 can transmit data from the security system 202 to the Internet, which can transmit the data to remotely located computing devices 204. The Internet and wireless networks can transmit data from remotely located computing devices 204 to the security system 202. In some embodiments, a security system 202 connects to a home's WiFi.

As illustrated in FIG. 3, one computing device 204 (e.g., a laptop, a smartphone, a mobile computing device, a television) can communicate with multiple security systems 202. In some embodiments, multiple computing devices 204 can communicate with one security system 202.

In some embodiments, the security system 202 can communicate (e.g., wirelessly 230) with a television 306, which can be a smart television. Users can view the television 306 to see a visitor and/or talk with the visitor.

The entire contents of the following patent application are incorporated by reference herein: U.S. patent application Ser. No. 14/612,376; filed Feb. 3, 2015; and entitled DOORBELL COMMUNICATION SYSTEMS AND METHODS.

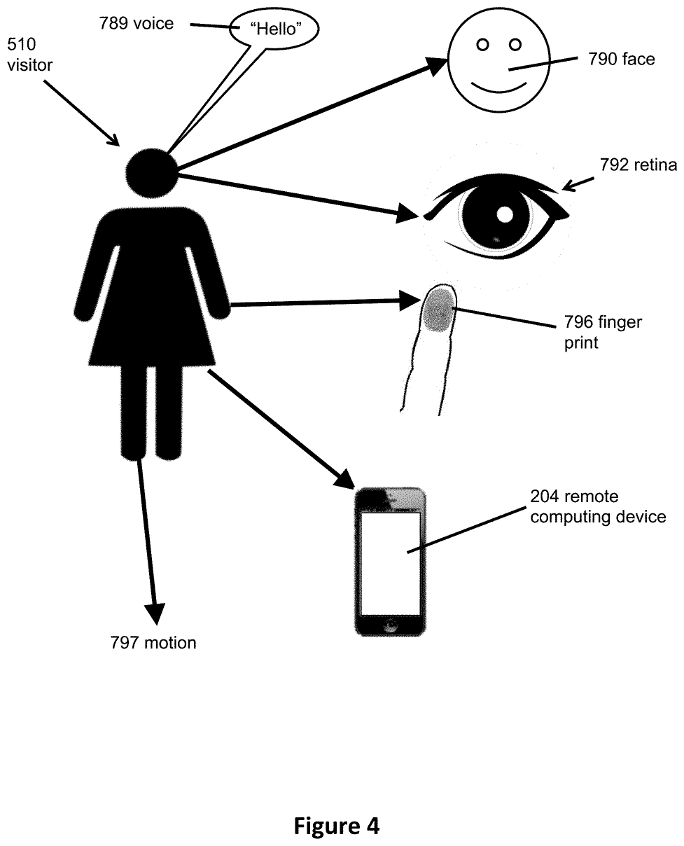

FIG. 4 of patent application Ser. No. 14/612,376 illustrates a communication system 310 that includes a security system 320, a doorbell button 212, a WiFi router 328, a server 332, and users 336. In step 340, a visitor initiates a communication request by pressing the doorbell button 212 or triggering a motion or proximity sensor. The visitor can trigger the motion or proximity sensor by approaching the security system 320. In step 350, the security system 320 connects or otherwise communicates with a home WiFi router 328. In step 360, the server 332 receives a signal from the WiFi router 328 and sends video and/or audio to the users 336 via a wireless network 364. In step 370, the users see the visitor, hear the visitor, and talk with the visitor. Step 370 can include using a software application to see, hear, and/or talk with the visitor. The visitor and users 336 can engage in two-way communication 374 via the internet or other wireless communication system even when the visitor and the users 336 are located far away from each other. Some embodiments enable users to receive communication requests and communicate with visitors via diverse mobile communication standards including third generation (“3G”), fourth generation (“4G”), long term evolution (“LTE”), worldwide interoperability for microwave access (“WiMAX”), and WiFi.

In some cases, the users 336 utilize the communication system 310 to communicate with visitors who are in close proximity to the users 336. For example, a user 336 located inside her home can communicate with a visitor located just outside the home via the communication system 310.

Referring now to FIG. 4 of the present application, the security system 202 may be configured to detect various indications of visitors. In response to detecting any of the various indications, the security system 202 may contact a specific resident associated with an indication of a respective visitor. In some embodiments, the security system 202 may be configured to utilize voice recognition to identify the voice 789 of a visitor 510 and contact a resident associated with the voice 789 of the visitor 510. For example, the security system 202 may contact Bob, a resident of a multi-family dwelling, in response to the security system 202 detecting the voice of Suzie, Bob's girlfriend.

As illustrated in FIG. 4, the security system 202 may detect a visitor's identity via facial recognition and then contact a specific resident associated with the face 790 of the visitor 510. For example, the security system 202 may contact Carol, an office manager of a company located within a commercial office building, in response to the security system 202 detecting the face of Fred, an applicant whom Carol will be interviewing for a job.

The security system 202 may be configured to identify a visitor by a motion 797 of a visitor 510. For example, the security system 202 may be configured to identify the visitor 510 by a motion of the visitor (e.g., gait analysis, analysis of a visitor's locomotion or body mechanics, etc.). In a specific example, the security system 202 may detect a visitor 510 approaching the building 300, to which the security system 202 is attached. As the visitor 510 approaches the building the security system 202 may analyze specific body movements of the visitor 510, which indicate the identity of the visitor 510. For example, the security system 202 may determine that the motion of the visitor is associated with a repairman who is scheduled to be at the building 300 within several minutes.

As shown in FIG. 4, the security system 202 can validate the identity of the visitor 510 from the initial identity, e.g., as determined by the visitor's motion, through secondary means. For example, as the visitor 510 approaches the security system 202, the security system 202 can then ask the visitor 510 to state his name. The security system 202 can then validate the visitor's identity through voice recognition.

Furthermore, the security system 202 may determine that a visitor is associated with a resident through various technologies, such as scanning of the visitor's retina 792 (i.e., retina scanning), detection of the visitor's remote computing device 204, scanning of the visitor's fingerprint 796 (i.e., fingerprint scanning), and the like. In some embodiments, the security system 202 may associate the visitor with the resident through various social networks. In this manner, the security system 202 may retrieve any identifying characteristics of a visitor and associate them with a particular resident. In some embodiments, the visitor may be associated with the resident through a previous identity of the visitor. For example, the resident may load an image or a voice of the visitor into the security system 202 to thereby recognize the visitor when the visitor approaches the security system 202.

In response to detecting an indication of the visitor's identity, the security system 202 may contact the resident associated with the visitor through various methods. In some embodiments, the security system 202 rings a chime of the resident. In some embodiments, the security system 202 initiates a communication session with the resident's remote computing device (e.g., sends a notification to the resident's smart phone). Even still, in some embodiments, the security system 202 emits an audible message within the vicinity of the resident. For example, if the security system 202 detects that Joe's friend Greg is located at the front door, the security system 202 may audibly announce within the home, “Greg is here.” It should be appreciated that any suitable method of contacting the resident may be implemented.

As well, the security system 202 may be configured to work in any type of building 300. For example, the building 300 may comprise a multi-family dwelling, a single family home, an office building, a warehouse, or any building configured to permanently or temporarily house residents.

The security system 202 may be configured to actively or passively determine the identity of the visitor 510. For example, the security system 202 may automatically detect a visitor 510 and then determine the visitor's identity. As well, the security system 202 may be configured to determine the visitor's identity in response to an input from the visitor, such as the visitor pressing the button 212.

Furthermore, the security system 202 may prompt the visitor 510 through various manners. For example, in response to the visitor 510 pressing the button 212, the security system 202 may audibly announce the names of various residents of the building 300 to determine which resident the visitor 510 is seeking to visit. Once the visitor 510 announces the resident's name, the security system 202 may determine the visitor's identity, as a validation that the visitor is in fact associated with the resident.

The security system 202 may also be configurable to elect to contact the resident associated with the visitor in response to various parameters. For example, the security system 202 may elect to contact or not contact the resident based on the time of day, such as based upon the actual time of day, or based upon the amount of outdoor light as detected by the security system 202. As well, the election parameters may be used in combination. For example, if the security system 202 detects that Fred's father is present, the security system 202 may elect to contact the resident Fred no matter what time of day Fred's father arrives. However, for someone not as closely connected to the resident Fred, such as a work colleague Barney, the security system 202 may elect to only contact Fred during daylight hours, and not contact Fred during nighttime hours. It should be appreciated that the security system 202 may be configured to elect to contact residents in response to any suitable election parameters.

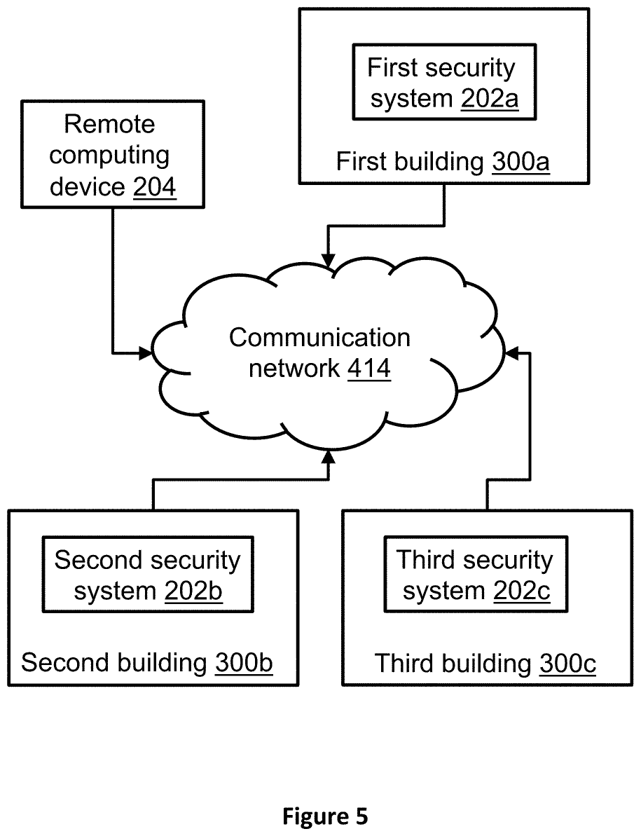

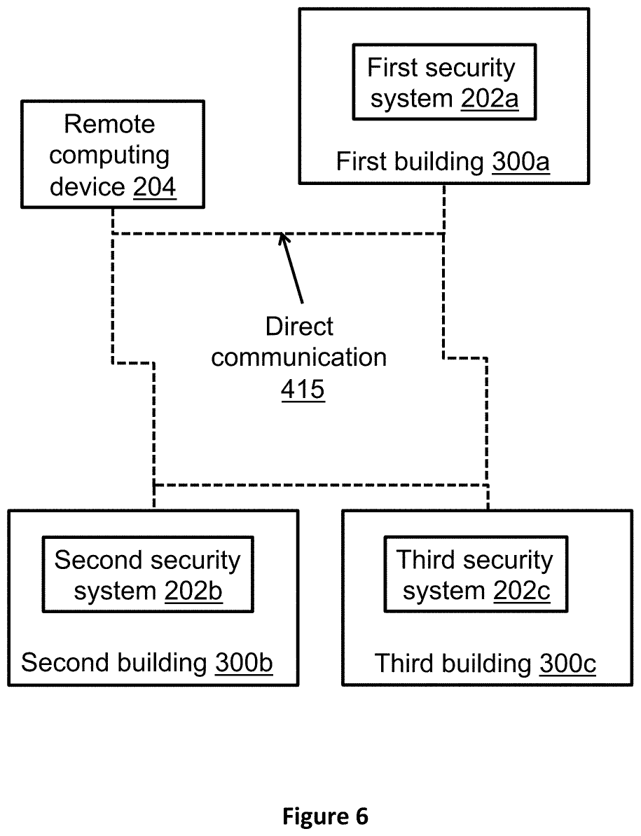

As illustrated in FIGS. 5 and 6, embodiments of the security system 202 may be configured to communicate with other security systems 202 that are communicatively coupled within a network. For example, a first security system 202a may be configured to receive data from a second security system 202b that is located remote to the first security system 202a. The data can comprise any type of information such as an indication of a high-risk visitor roaming the neighborhood (e.g., a prowler that has been detected in a neighborhood). The data received by the first security system 202a may include identifying characteristics of the high-risk visitor.

Accordingly, the first security system 202a uses the data to determine whether a visitor 510 who is approaching the first building 300a is in fact the high risk visitor. This may be accomplished by the first security system 202a determining that the identity of the visitor 510 substantially matches the identity of the high-risk visitor using any of the embodiments described throughout this disclosure.

In response to detecting the presence of the high-risk visitor, the first security system 202a can then be configured to initiate an alert to notify the resident of the first building 300a and/or anyone located within the area. In some embodiments, the first security system 202a can be configured to secretly notify the resident so as not to spook the high-risk visitor, such as by initiating a communication session with a remote computing device 204 to thereby inform a user of the remote computing device 204 of the presence of the high-risk visitor. In some embodiments, the first security system 202a can be configured to initiate an alarm to thereby scare the high-risk visitor to flee the premises. In some embodiments, the alert may comprise illuminating a light on the first security system 202a, and/or emitting a noise with a speaker of the first security system 202a.

It should be appreciated that the network or ecosystem of security systems 202 may be communicatively coupled indirectly through a communication network 414, such as through a cloud computer, as shown in FIG. 5. As well, the network of security systems 202 may be communicatively coupled directly to each other, as shown in FIG. 6.

The network of security systems 202 may be implemented in various applications, such as security systems 202 being attached to various homes within a neighborhood (e.g., separate homes located more than 50 feet from each other). As well, the security systems 202 may be attached to various units within one building, such as apartment units within an apartment building. As well, any number of security systems 202 may be linked through the network, such as at least two security systems 202, at least three security systems 202 (i.e., addition of at least a third security system 202c as shown in FIGS. 5 and 6, as attached to a third building 300c), and at least four or more security systems 202.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding section may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

What is claimed is:

1. A method of operating a doorbell system comprising a doorbell including a housing, a speaker, a microphone, a camera, and a motion detector, the method comprising:
detecting, via a component selected from the group consisting of the microphone, the camera, and the motion detector, a first visitor;
capturing, via the component selected from the group consisting of the microphone, the camera, and the motion detector, an identity trait of the first visitor;
searching an unwelcome visitor database to determine whether the identity trait of the first visitor matches an identity trait of an unwelcome visitor who has previously visited a building to which the doorbell system is attached;
receiving at least one image; and
initiating a communication session with a remote computing device of a first resident in response to determining that the identity trait of the first visitor and the identity trait of the unwelcome visitor are different.

2. The method of claim 1, further comprising electing to contact the first resident based on at least one of a first contact parameter related to the first visitor and a time at which the doorbell system detects an indication of the first visitor.

3. The method of claim 1, further comprising electing to contact the first resident based on a first contact parameter related to the first visitor and based on a time at which the doorbell system detects an indication of the first visitor, wherein the first contact parameter comprises the identity trait of the first visitor.

4. The method of claim 1, further comprising, in response to detecting the first visitor, emitting a noise with a chime located remotely relative to the doorbell system, wherein the chime is communicatively coupled to the doorbell system.

5. The method of claim 1, wherein contacting the first resident comprises initiating a first communication session with a first remote computing device of the first resident.

6. The method of claim 1, wherein receiving the at least one image comprises receiving at least one image from an online social network.

7. A method of operating a doorbell system comprising a housing, a speaker, a microphone, a camera, and a motion detector, the method comprising:
detecting, via the doorbell, a first visitor;
detecting, via the doorbell, a second visitor;
capturing, via a component selected from the group consisting of the microphone, the camera, and the motion detector, an identity trait of the first visitor and an identity trait of the second visitor;
searching, via the doorbell system, an unwelcome visitor database to determine whether the identity trait of the first visitor matches an identity trait of an unwelcome visitor identity which has previously visited a building to which the doorbell system is attached;
searching, via the doorbell system, the unwelcome visitor database to determine whether the identity trait of the second visitor matches the identity trait of an unwelcome visitor identity which has previously visited the building to which the doorbell system is attached;
receiving at least one image;
initiating a communication session with a remote computing device of a first resident in response to determining that the identity trait of the first visitor and the identity trait of the unwelcome visitor are different; and
initiating a communication session with a remote computing device of a second resident in response to determining that the identity trait of the second visitor and the identity trait of the unwelcome visitor are different.

8. The method of claim 7, further comprising contacting the first resident in response to the first resident being associated with the first visitor and contacting the second resident in response to the second resident being associated with the second visitor.

9. The method of claim 7, further comprising, in response to detecting the first visitor, emitting a noise with a chime located remotely relative to the doorbell system, wherein the chime is communicatively coupled to the doorbell system.

10. he method of claim 7, wherein contacting the first resident comprises initiating, in response to detecting via facial recognition the first visitor, a first communication session with a first remote computing device of the first resident and wherein contacting the second resident comprises initiating a second communication session with a second remote computing device of the second resident.

11. The method of claim 7, further comprising electing to contact the first resident based on a first contact parameter, wherein the first contact parameter is at least one of related to the first identity and comprises the identity trait of the first visitor, and electing to contact the second resident based on a second contact parameter, wherein the second contact parameter comprises the identity trait of the second visitor.

12. The method of claim 7, wherein contacting the first resident comprises initiating a first communication session with a first remote computing device of the first resident, and wherein contacting the second resident comprises initiating a second communication session with a second remote computing device of the second resident.

13. The method of claim 7, further comprising electing to contact the first resident based on a first time at which the doorbell system detects a first indication of the first visitor and electing to contact the second resident based on a second time at which the doorbell system detects a second indication of the second visitor.

14. he method of claim 13, further comprising electing to contact the first resident based on a first contact parameter, wherein the first contact parameter comprises the identity trait of the first visitor.

15. The method of claim 7, wherein receiving the at least one image comprises receiving at least one image from an online social network.

16. A method of operating a doorbell system comprising a doorbell including a housing, a speaker, a microphone, a camera, and a motion detector, the method comprising:
detecting, via the doorbell, a first visitor;
capturing, via a component selected from the group consisting of the microphone, the camera, and the motion detector, an identity trait of the first visitor;
searching, via the doorbell system, an unwelcome visitor database to determine whether the identity trait of the first visitor matches an identity trait of an unwelcome visitor which has previously visited a building to which the doorbell system is attached;
receiving at least one image; and
refraining from initiating a communication session with a remote computing device of a first resident in response to determining that the identity trait of the first visitor matches the identity trait of the unwelcome visitor.

17. The method of claim 16, further comprising sending an alert to the remote computing device, wherein the alert comprises:
an identity of the unwelcome visitor; and
comprises a number of times the unwelcome visitor has previously visited the building to which the doorbell system is attached.

18. The method of claim 16, further comprising selecting, via the remote computing device, a sound to be emitted by the doorbell in response to determining, via the doorbell, the identity trait of the first visitor matches the identity trait of the unwelcome visitor.

19. The method of claim 16, further comprising:
capturing, via the camera, an image of the first visitor; and
transmitting the image of the first visitor to a remote server for facial recognition analysis.

20. The method of claim 16, wherein receiving the at least one image comprises receiving at least one image from an online social network.
